(19) United States
(12) Patent Application Publication
(10) Pub. No.: US 2016/0350096 A1
(43) Pub. Date: Dec. 1, 2016

(54) SYSTEMS AND METHODS FOR PROVIDING INTEROPERABLE APPLICATIONS TO EMBEDDED ELECTRONIC DEVICES

(71) Applicant: eConais, Inc., San Jose, CA (US)

(72) Inventors: Konstantinos Pipilas, Patras (GR); Dimitrios Leonardos, Patras (GR)

(21) Appl. No.: 14/721,994

(22) Filed: May 26, 2015

(51) Int. Cl. G06F 9/445

(52) U.S. Cl. CPC G06F 8/65; G06F 8/67

(57) ABSTRACT

An embedded architecture that allows applications to interoperate on embedded, or Internet of Things, devices with different hardware and system software components is described. The embedded architecture includes a core framework that abstracts hardware into hardware interfaces and modules with standardized objects. The core framework further abstracts system software components into modules with standardized objects. Applications and libraries are configured to operate with the standardized objects of the modules, allowing for interoperability of applications and libraries in spite of differences in hardware and system software specifications. Applications and libraries of the embedded devices may be replaced at runtime with new, updated, or different applications and libraries.

### FIELD OF THE INVENTION

The present embodiments relate to embedded systems, and more particularly, to embedded systems architecture.

### BACKGROUND OF THE INVENTION

Embedded electronic devices, such as smart lights, smart appliances, or smart HVAC systems in the home setting, or different machines along a factory line, typically operate applications intended for machine-to-machine (“M2M”) communications programmed to serve a specific scenario. Such applications are written for specific hardware, without interoperability for using with different hardware. For example, applications written for one smart thermostat are not interoperable with another smart thermostat.

It is desirable for applications and services to be interoperable between different embedded electronic devices. It is also desirable for interoperable applications and services to be exchanged between different embedded electronic devices.

### BRIEF SUMMARY OF EMBODIMENTS OF THE INVENTION

Some embodiments include a system and method for providing interoperable applications to an embedded electronic system. Embedded electronic systems are typically computer systems embedded into a larger device or mechanical system, with real-time constraints and designed to perform a dedicated function. For example, embedded systems are integrated into a locking doorknob to control access, and to schedule such access. In another example, embedded systems are embedded into a doll to provide a reaction of different movements or sounds to different stimuli detected by various sensors. Embedded systems are also used in industrial applications to provide mechanical machine components with advanced computational and communicative functionality.

Embedded electronic devices and systems, such as an embedded device with network connectivity operating on an Internet of Things (“IoT system”) are provided with an embedded architecture that allows applications to interoperate on IoT systems having different hardware and system software from each other. An embedded architecture includes a core framework (“Core”), user application programs (“Apps”), and user libraries (“Libs”). The Core abstracts the specific hardware of an IoT system into modules with standardized interfaces for allowing interoperable Apps and Libs to access hardware functions. The Core also abstracts system software components, such as the device's kernel, network stack, and security protocol into modules with interfaces for allowing interoperable Apps and Libs to access system functions. Apps and Libs can therefore be developed for a set of standardized modules and interfaces, allowing a particular App to be run on different IoT systems without customizing it to work with any particular hardware and system specifications.

The embedded architecture further provides for a Core be integrated with a programming language interpreter that provides an IoT system with the ability to execute scripts of instructions that were not previously compiled as an App or Lib.

The embedded architecture further provides for interoperable Apps and Libs to be replaced at runtime, without stopping the Core, allowing an IoT to change its soft functionality on the fly. Network connectivity allows for Apps to be downloaded from an unlimited number of sources from the Internet, from local storage, or from a locally connected IoT system. The embedded architecture also allows the Core to be replaced with an updated or different Core.

The embedded architecture further provides for two IoT systems to share, exchange, and push Apps onto other IoT systems.

The embedded architecture further provides for two IoT systems to work together, each executing coordinated but distributed Apps to achieve an objective or function.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an example of an operating platform for an embedded system configured to run interoperable applications, libraries, or cores, according to some embodiments.

FIG. 2 is a block diagram showing the relationship between hardware and system software components of an IoT system and their interfaces and modules as generated by the embedded architecture, according to some embodiments.

FIG. 3 is a block diagram illustrating an example of a mapping of the relationship of modules created for an individual or a set of hardware components of an embedded system, according to some embodiments.

FIG. 4. is a block diagram illustrating a mapping of the relationship between system software components and their modules, according to some embodiments.

FIG. 5 is a flow diagram illustrating a process for replacing a running App or Lib, referred hereinafter as an “App Update,” according to some embodiments.

FIG. 6 illustrates one example of the App Update process according to some embodiments.

FIG. 7 illustrates an example of a process for replace a Core of an IoT system with a new Core, according to some embodiments.

FIG. 8 illustrates Device Discovery phase of an App Exchange process, according to some embodiments.

FIG. 9 illustrates one example of the structure of a beacon packet, according to some embodiments.

FIG. 10 illustrates one example of the App Exchange process according to some embodiments.

### DETAILED DESCRIPTION OF EMBODIMENTS

In the following description numerous specific details have been set forth to provide a more thorough understanding of embodiments of the present invention. It will be appreciated however, by one skilled in the art, that embodiments may be practiced without such specific details or with different implementations for such details. Additionally some well known structures have not been shown in detail to avoid unnecessarily obscuring the present embodiments.

Other and further features and advantages of the present embodiments will be apparent from the following descriptions of the various embodiments when read in conjunction with the accompanying drawings. It will be understood by one of ordinary skill in the art that the following embodiments and illustrations are provided for illustrative and exemplary purposes only, and that numerous combinations of the elements of the various embodiments of the present invention are possible. Further, certain block diagrams are not to scale and are provided to show structures in an illustrative manner. Exemplary systems and processes according to embodiments are described with reference to the accompanying figures. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like.

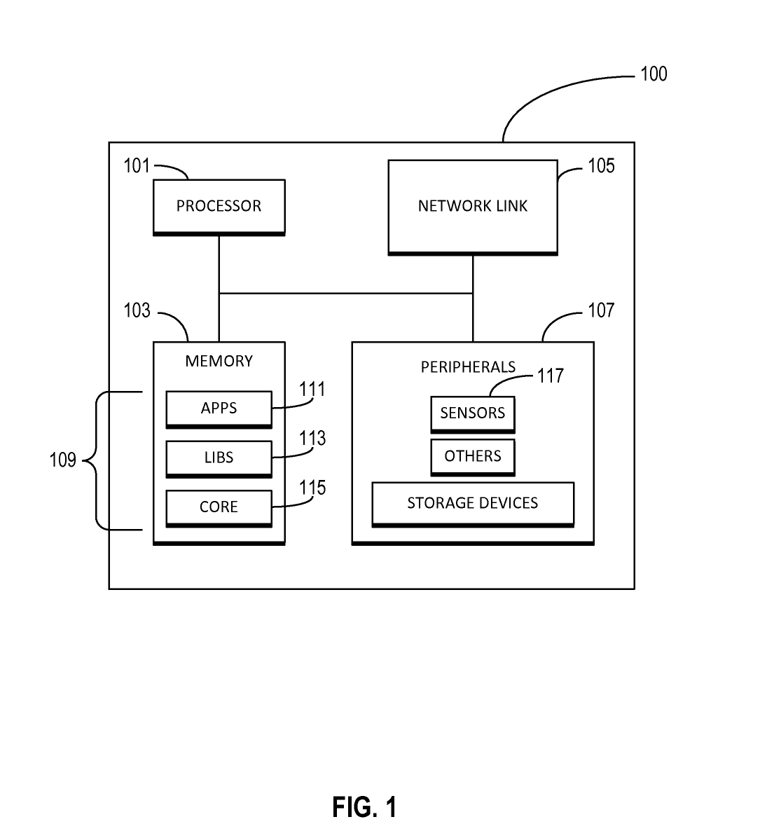

FIG. 1 illustrates an example of an embedded architecture for an embedded system configured to run interoperable applications, libraries, or cores, according to some embodiments.

In accordance with present embodiments of the invention, an Internet of Things (“IoT”) device system 100 includes a micro-processor 101 for running the system program, a memory 103 for storing the system program, a network link 105, such as wireless radios or Ethernet, for communicating with a remote computer system, other remote server or another IoT system, and peripheral devices 107 for interacting with the environment and with the user, such as buttons, light-emitting diodes (LEDs), and sensors. IoT system 100 has very limited resources. Typically, micro-processor 101 is not able to run any operating system. Rather, IoT system 100 is capable of running simple and standalone embedded applications using a scheduler. In some embodiments, hardware components within IoT system 100, such as micro-processor 101, memory 103, peripheral devices 107, and network link 105 are not provided by the same manufacturer.

The system program stored on memory 103 includes one or more user application programs (“Apps”) 111, one or more user libraries (“Libs”) 113 that provide additional services to the Apps and a core framework (“Core”) 115 that communicates with IoT system 100's hardware components and provides all the required services to Apps 111 and Libs 113 in order to control, configure and collect information from IoT system 100.

According to present embodiments of the invention, memory 103 stores an embedded architecture 109 for which application development may occur without providing a development environment specifically for embedded systems or IoT systems. In some embodiments, embedded architecture 109 is preloaded by the manufacturer during manufacturing, or loaded by flashing a firmware image to the embedded device to replace any preloaded firmware. Embedded architecture 109 comprises Apps 111, Libs 113 and Core 115. IoT system 100 is capable of running embedded architecture 109.

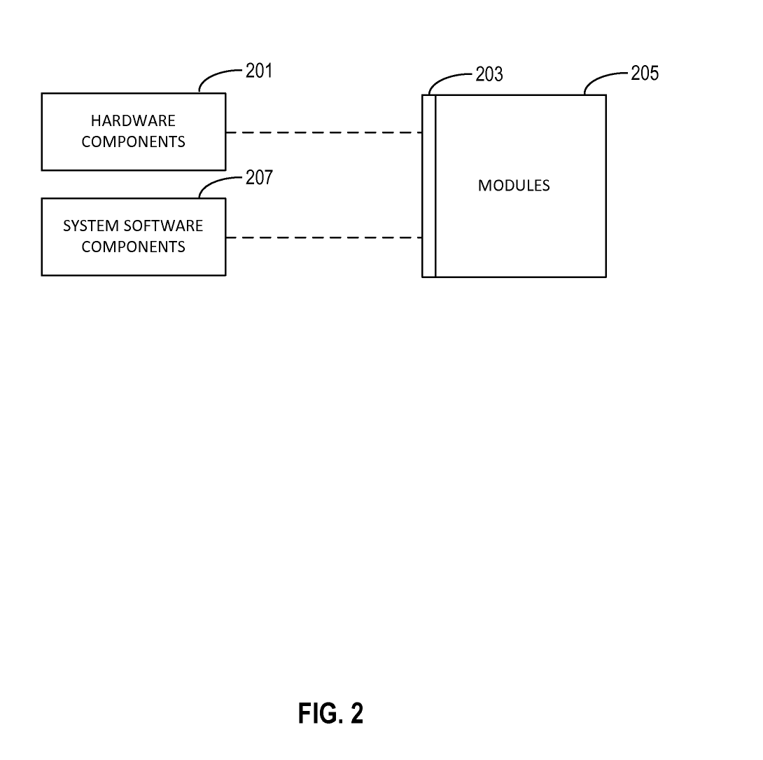

With reference to FIG. 2, through an automated process, embedded architecture 109 provides complete hardware abstraction for hardware components 201 within IoT system 100. First, a hardware abstraction layer is provided by embedded architecture 109 in a low level language such as assembly language or C language. The hardware abstraction layer contains sequences of instructions that brings hardware components 201 into a functional state and provides a hardware interface 203. A hardware interface 203 is a set of data types and functions that provides access to IoT system 100's hardware components and system resources, such as multi-processor 101, memory 103, network link 105, and peripheral devices 107. The sequences of instructions are based on the vendor's documentation of each hardware component. The hardware abstraction layer provides the advantage of enabling similar hardware components made by different manufacturers to be used in a common way by providing standard interfaces for similar hardware. For example, LED light controllers made by different manufacturers are provided with a common LED light controller interface by implementation of the hardware abstraction layer.

Next, automated processes in embedded architecture 109 provide the hardware interfaces with modules 205. A module simplifies the complexity of hardware by defining objects that can be used by modern high-level programming languages. Objects of a module are logical structures that include one or more data structures for holding data and functions, also known as methods. Modules define how objects operate on data that was received as input into the hardware interfaces.

According to some embodiments, in an automated process, embedded architecture 109 further “converts” system software components 207, such as the kernel, network stack, security & other protocols into additional modules. Such conversions provide the benefit of allowing an application developed for one embedded system to operate on other embedded systems, whereas previously such application would be incompatible with such other embedded systems and would need to be modified to work with such other embedded systems.

In some embodiments, embedded architecture 109 may be viewed as a hybrid between an operating system and a software suite that is suited for IoT systems and other electronic systems with very limited power and memory resources. While on the one hand, Core 115 of embedded architecture 109 provides functionality that resembles an operating system, on the other hand, embedded architecture 109 provides functionality that resembles a software suite in that it provides a number of different Apps 111 and Libs 113 to the user.

An example of an embedded device is a Wi-Fi-enabled thermostat that is capable of adjusting the temperature of a number of heating or cooling devices in the house (e.g., air conditioning, heating and ventilation units). According to some embodiments, the Wi-Fi-enabled thermostat can be controlled directly from a touch screen user interface or buttons on the thermostat, or remotely from a smart phone or other network device by receiving signals through a Wi-Fi radio and communication protocol. The Wi-Fi-enabled thermostat includes:
a) a microprocessor for running the thermostat program;
b) a memory to store the thermostat program;
c) a Wi-Fi transceiver and integrated circuit for providing network communications with another network device (e.g., smart phone, personal computer, etc.);
d) buttons and/or touch screen user interface to configure the thermostat and to display useful information;
e) batteries for autonomous operation;
f) heat sensors for obtaining temperature readings, light sensors for obtaining daylight readings, etc.; and
g) LEDs for providing backlight and status information, etc.

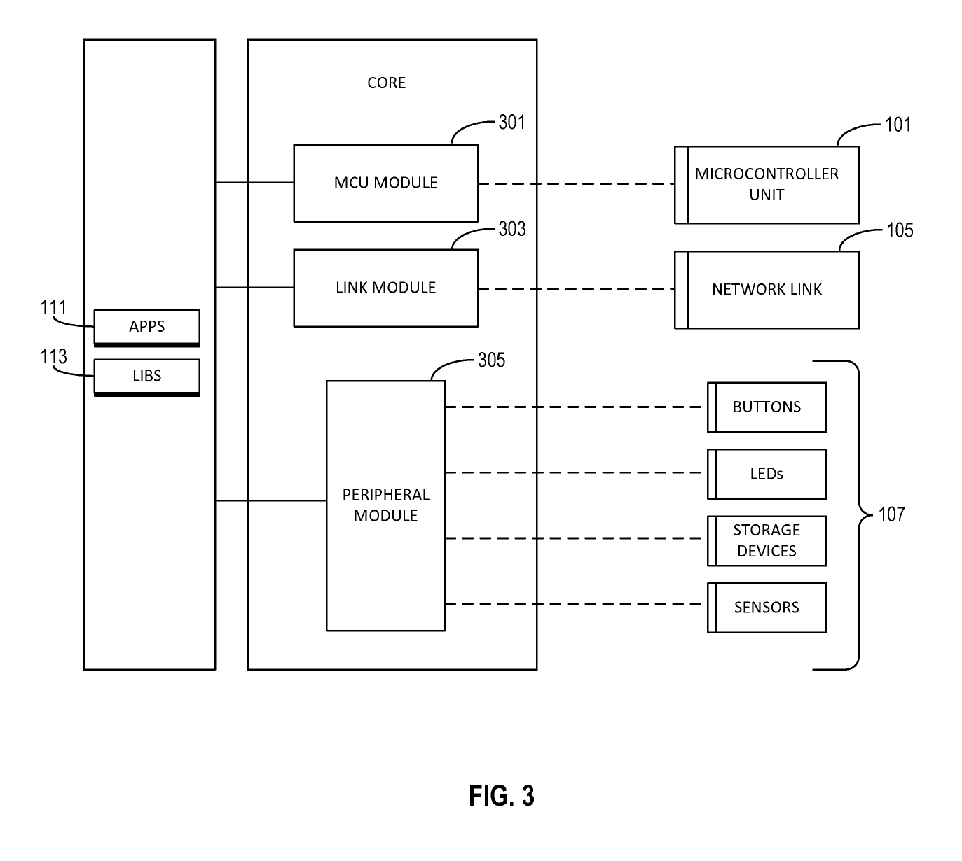

FIG. 3 is a block diagram illustrating an example of a mapping of the relationship between modules and hardware, according to some embodiments. Modules in this example embodiment include:

Microcontroller Unit (“MCU”) module 301. This module provides all the necessary objects to control MCU 101 of IoT system 100, including but not limited to power saving, memory, interrupts and other resources. The created objects are further categorized based on the MCU architecture and manufacturer.

Link module 303. This module provides all the necessary objects to control network link 105 of IoT system 100. Network link 105 provides communications by various wireless protocols, including but not limited to Wi-Fi, Bluetooth, ZigBee, Ethernet.

Peripheral module 305. This module provides all the necessary objects to control the various peripherals 107 of IoT system 100, including but not limited to buttons, LEDs, storage devices, and sensors.

As shown in FIG. 3, Apps 111 and Libs 113 interface with objects provided by MCU module 301, link module 303 and peripheral module 305.

In accordance to some embodiments, an embedded system is a single-chip or two-chip solution that combines an MCU and a network or other communication link into one integrated circuit device. In such embodiments, a platform module is used to provide all the necessary objects to control the MCU and communication link hardware.

In accordance to some embodiments, modules for hardware components interact and exchange information with Apps 111 and Libs 113, including exporting to Apps 111 and Libs 113 information from the hardware components.

Standard modules for hardware provides the advantage of allowing developers to use and compile a single set of code for a number of different hardware components, instead of re-writing different code customized to the particular hardware controller. Example 1 illustrates the complex and specific output provided for a typical interface compared with the readable output provided from a standardized module.
Complex source code for GPIO controller:
#include “gpio.h” /* the gpio interface */
gpio_write(gpio, 1); /* value: 1 is ON */
Simplified and readable source code for standardized module
and object for LED lights:
import led_module
myled is of led_module;
myled.on( )

### Example 1

In Example 1, according to some embodiments, ‘myled’ object, which is defined as an object of ‘led_module’, has properties and methods to control an LED in an IoT system. In contrast, a typical interface employs a generic function to control a general-purpose input/output (GPIO) pins of the relevant LED in the device, where a parameter of “1” turns the device on, and requires additional comments in the source code in order to explain the meaning of the source code. Unlike the function “myled.on( )” whose name clearly expresses the result of turning an LED light on, generic functions do not generally have useful names that express how a function is related with the operation of an LED in an IoT system.

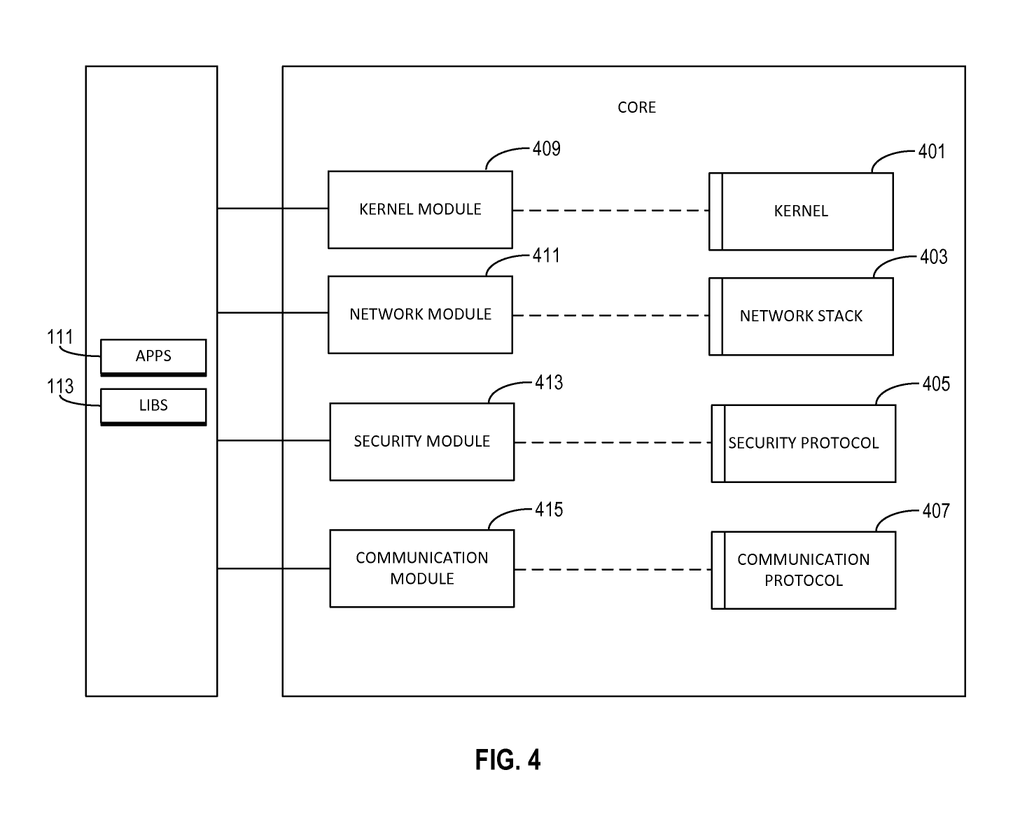

FIG. 4 is a block diagram illustrating a mapping of the relationship between system software components and their modules, according to some embodiments.

Core 115 “converts” system software components, such as the kernel 401, network stack 403, security 405 and communication protocols 407 into modules. In some embodiments, the software components are converted into a kernel module 409, a network module 411, a security module 413, and a communication module 415. The software component modules 409, 411, 413 and 415 interact and exchange information with Apps 111 and Libs 113, including exporting to Apps 111 and Libs 113 the information from the software components.

In some embodiments, Apps 111 and Libs 113 create objects that use the aforementioned modules created by Core 115 of the software and hardware components. An object created by Apps 111 and Libs 113 performs a set of actions that affect IoT system 100 based on the module to which the object belongs. By combining a number of objects, an App can operate and control IoT system 100. Accordingly, by converting the hardware components and software components into modules that objects created by Apps 111 and Libs 113 can use, Core 115 provides resources to use the embedded architecture as an effective operating system for IoT system 100.

The following source code is an example of an App that uses modules socket, wlan, time, and led that were abstracted from hardware and system software components, according to some embodiments. The source code for this App is written in Python programming language, one of the high-level languages supported by the embedded architecture. The App comprises instructions for establishing a wireless LAN connection, and for turning on and off an LED light in an embedded device in response to establishing a wireless LAN connection, and when receiving UDP packets. In present embodiments, such App is interoperable on any IoT system 100 having embedded architecture 109 regardless of differences in hardware sources.
# import modules
import socket
import wlan
import time
import led
# Turn LED OFF
led1=led.LED(2, 0)
# Connect to WLAN
network=wlan.wlan( )
network.connect(“wubby”, “12345678”)
# Indicate WLAN connection
led1.ON( )
time.sleep(1000)
led1.OFF( )
# Initialize sockets
sock=socket.socket(socket.AF_INET, socket. SOCK_DGRAM)
sock.setsockopt(socket.SOL_SOCKET, socket. SO_BROADCAST, 1)
sock.bind((“255.255.255.255”, 5005))
# receive UDP packets
while True:
   rec=sock.recv(1)
   if(rec[0]==1):
      led1.ON( )
   else:
      led1.OFF( )

### Example 2

According to some embodiments of the present invention, Core 115 is integrated with a programming language interpreter that provides IoT system 100 with the ability to execute direct instructions in IoT system 100 that have not been previously compiled in the Apps 111, Libs 113 or Core 115 of IoT system 100. The programming language interpreter analyzes and parses the instructions and unrolls the resulted byte code into native machine code for faster execution to benefit the power and memory limitations in IoT system 100. The ability to execute direct instructions in the IoT system, as described above, allows Scripting, which is execution of a collection of instructions from a file, or instructions directly received one by one, that will perform a specific action in the IoT system. Apps or Libs are also formed from collections of instructions, depending on the nature of instructions. For example, according to some embodiments, an App is a complete set of instructions that operate IoT system 100 while Libs are used for implementing specific actions in IoT system 100 and act as helper modules in the Apps. An App can contain/import one or more Libs.

Scripting allows a user or an autonomous computer system to change the behavior of an IoT system at runtime, to perform App Updates and Core Updates, to collect information from an IoT system and to perform various status checks. Scripting can also be initiated by other Apps of other IoT systems. In some embodiments, Apps 111 and Libs 113 are both scripts as well.

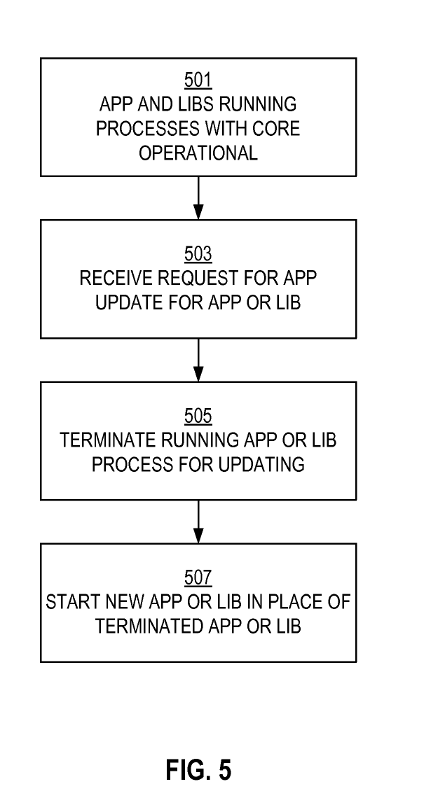

In accordance with additional aspects of embodiments of the present invention, Core 115 allows the embedded architecture to replace Apps 111 and Libs 113 at runtime, without powering off IoT system 100, by keeping Core 115 operational. FIG. 5 is a flow diagram illustrating a process for replacing a running App or Lib, referred hereinafter as an “App Update,” according to some embodiments. At step 501, each App and Lib is running its own process. Such process can be a simple task or a thread, in the case where a real-time kernel has been integrated. At step 503, a request is received from a user, from another IoT system or other computer system, or automatically generated from the IoT system 100, to update the running App. At step 505, the running process is terminated. At step 507, a new process is started in its place running the new App or Lib. In some embodiments, the source of the new Apps and Libs can be locally stored and retrieved, such as from a storage peripheral such as in USB flash storage or SD card storage. In some embodiments, new Apps and Libs are stored and accessed from remote locations, such as from a remote computer system that can be accessed using the supported network communication protocol, for example, using TCP over Wi-Fi.

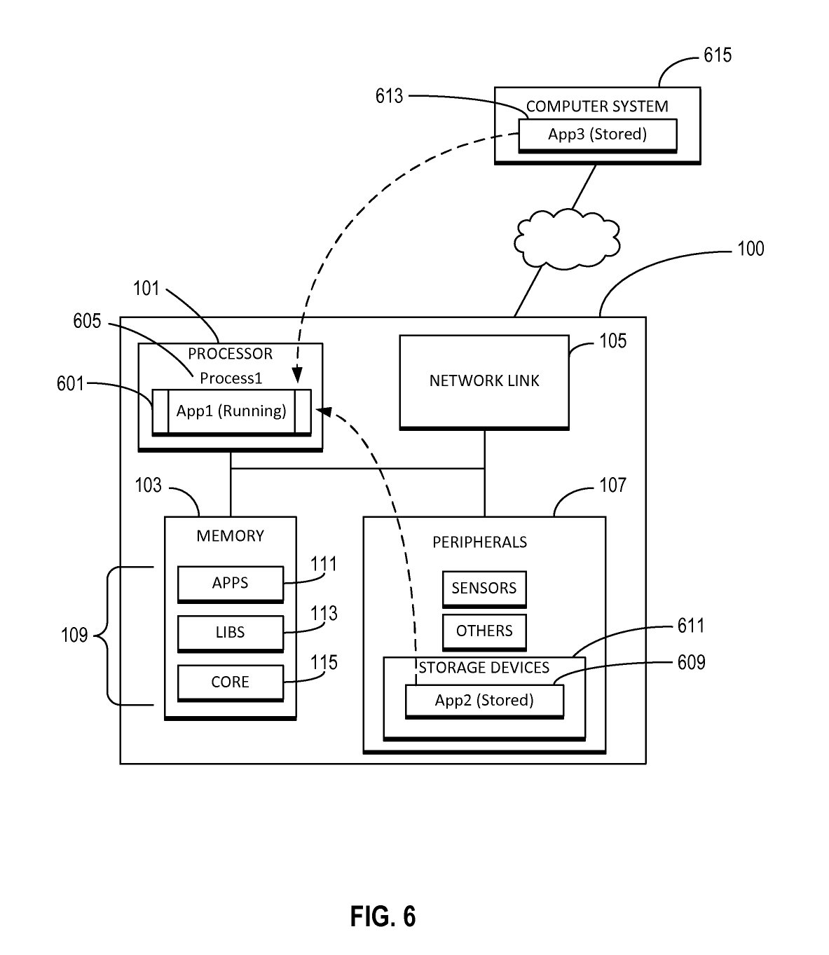

FIG. 6 illustrates one example of the App Update process according to some embodiments. Initially App1 601 is loaded in the processor 101, running in process1 605. During App Update, process1 605 is terminated and process2 607 is initiated with App2 609 that is loaded from storage peripheral 611 in the IoT system 100. Alternatively App3 613 could be loaded from a remote computer system 615. The App Update process can be used to replace Apps and Libs on IoT system 100 from remote computer systems, including web application stores and other marketplaces providing a selection of Apps and Libs for download and installation.

A user may also use a smart phone, tablet, or other mobile computer system running a mobile application program to detect and discover local IoT systems, to browse, on a remote computer system via an internet connection, for Apps and Libs that are suitable to the IoT systems, and to initiate App Updates on selected IoT systems to replace Apps and Libs on the IoT systems. Mobile computer systems including devices running mobile platforms such as Android, iOS, Windows Mobile, Blackberry and other mobile platforms.

Scripting and App Update, together with providing modules for hardware components and software components, provide the resources necessary to fulfill the hybrid role of the embedded architecture 109 as both a software suite and an operating system.

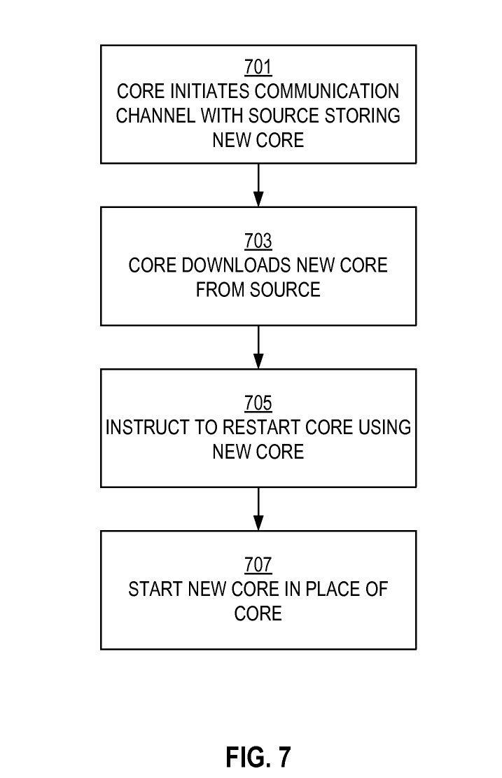

FIG. 7 illustrates an example of a process hereinafter referred to as Core Update, in which Core 115 of IoT system 100 is replaced with a new Core. In some embodiments, the new Core is stored locally, for example, in a storage peripheral, or stored remotely, for example, in a remote computer system that can be accessed using a supported network communication protocol, such as TCP over Wi-Fi. According to some embodiments, at step 701, Core 115 initiates a communication channel with the source of the new Core. At step 703, Core 115 downloads the new Core to the memory in the IoT system, or to an extra memory dedicated to storing Core images. At step 705, IoT system 100 is instructed to restart and load the new Core. At step 707, IoT system 100 restarts, loading the new Core, effecting replacement of the original Core.

In addition to new Apps and Libs that are stored on remote computer systems, or stored locally on device peripherals, new Apps and Libs can also be installed from another IoT system, in a process hereinafter referred to as an App Exchange. In some embodiments, an App Exchange is initiated manually by the user from a mobile computer system. In other embodiments, an App Exchange is initiated automatically by a target IoT system. For example, an App is pushed to a target IoT system based on nearby activity of other IoT systems or other triggering events.

In some embodiments, an IoT system causes an App or Lib that it is running or storing locally through its peripherals to replace an App or Lib currently running on a target IoT system. For example, a Web-connected IoT system and a target IoT system are part of a network of smart devices connected by different wireless protocols and signal types, including one or more of ZigBee, Bluetooth, or Wi-Fi. The Web-connected IoT system that has received an updated App or Lib from the internet pushes the updated App or Lib to a target non-Web-connected IoT system. In some embodiments, after downloading and installing the update, the Web-connected IoT system transmits a signal, such as beacons with a flag or other information indicating that the IoT system has an update available, to other IoT systems on the network. Once the target non-Web-connected IoT system has received the update, it can execute an App Exchange process to push the update onto other IoT systems which need the update. As further described below, a non-Web-connected IoT system which has not been updated, and detects such a flag raised in a beacon, would initiate the App Exchange process that pushes the update to the non-Web-connected IoT system.

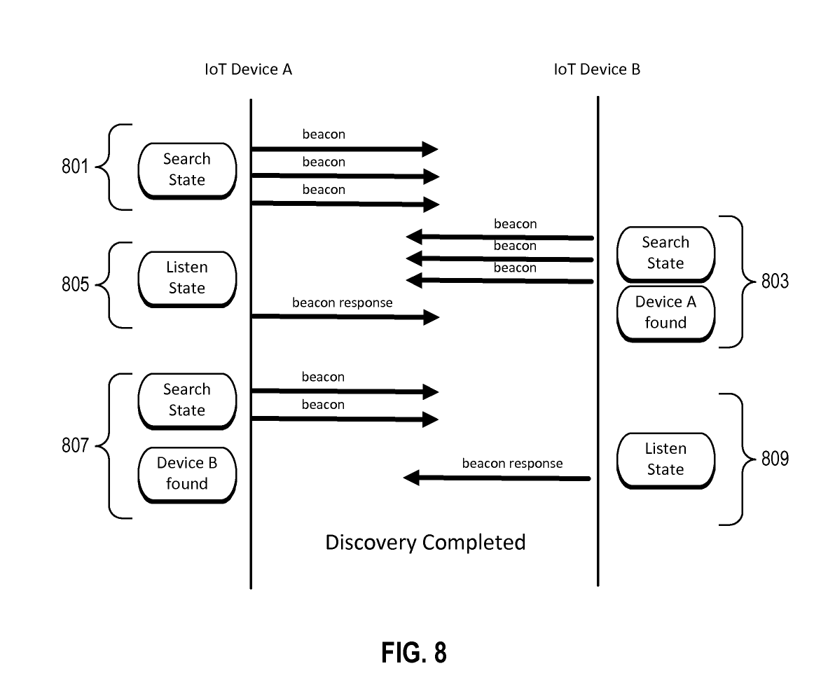

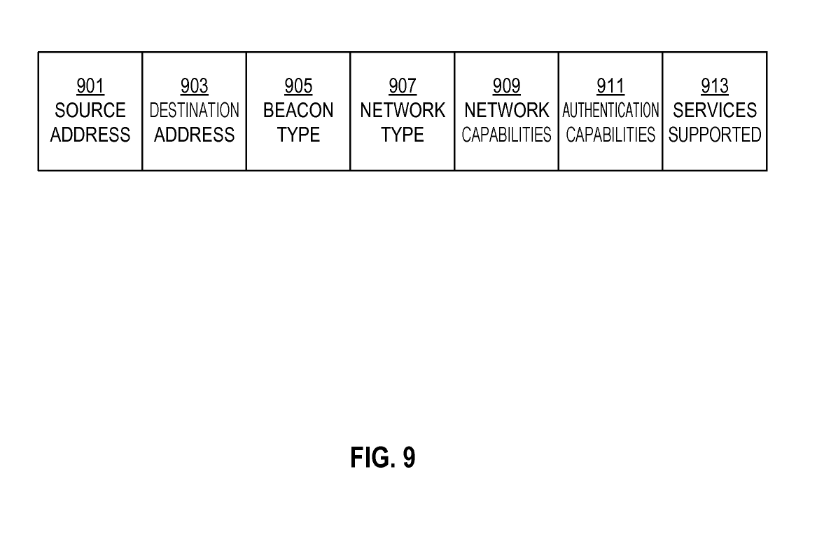

According to some embodiments, Core 115 executes App Exchange to cause nearby IoT systems to perform App Updates between each other. App Exchange includes four phases: Device Discovery, Negotiation, Authentication, and Data Transfer. During the Device Discovery phase, which is further described below with reference to FIG. 8, two IoT systems discover themselves by use of beacons. According to some embodiments, beacons are data packets with information about the App and Libs that IoT system 100 is using, the services that are supported, authentication information and details about IoT system 100's specific type, for example, a thermostat Wi-Fi device. Beacon responses are data packets received from discovered IoT systems which also include information about the discovered IoT systems. Beacons and their relevant responses can be transmitted over any available network interface and wireless medium. In some embodiments, beacons and their relevant responses are broadcast packets with a format as shown in FIG. 9:
Source Address 901. The source address of the device, depending on the network this can be either the mac address of the device or the IP Address of the device.
Destination Address 903. The address of the destination device that the beacon will be sent. It can be either a MAC address or the IP address of the destination device. According to some embodiments, a broadcast address is used to send the beacon to multiple destinations.
Beacon Type 905. Beacon or Beacon response.
Network Type 907. The type of network, for example WiFi, Bluetooth, Zigbee, etc.
Network capabilities 909. The supported capabilities of the device with regard to the network.
Authentication Capabilities 911. The authentication schemes supported by the device, if any.
Services Supported 913. The supported services of the device. For example, a device acts as a thermostat that is able to accept user input from a touch screen or keyboard and to communicate and exchange information with a remote server.

With further reference to FIG. 8, which illustrates the Discovery phase, according to some embodiments, each IoT system alternates between a search state and a listen state to obtain information about each other through the sending of beacons and the receiving of beacon responses. In a search state, a system sends beacons and can receive beacon responses, but it does not detect beacons sent from another system. In a listen state, a system listens for beacons, and if heard and accepted, sends a beacon response indicating acceptance of the other system's beacon. At stage 801, IoT system A in a search state sends beacons in order to elicit beacon responses from IoT system B. However, at stage 803, IoT system B, is also in a search state, and is also sending beacons to IoT system A. Neither device is listening for or responding to the other's beacons.

At stage 805, IoT system A enters a listen state while IoT system B is still in a search phase. IoT system A hears and accepts the transmitted beacon from IoT system B, and sends beacon responses to IoT system B. IoT system B is still in a search state, and can receive a beacon response. Upon receiving a beacon response from IoT system A, IoT system A is discovered by IoT system B.

Vice versa needs to occur for IoT system B to be discovered by IoT system A. At stage 807, IoT system A enters another search state, and sends beacons. At stage 809, IoT system B has entered a listen state, and detects IoT system A's beacons, and sends a beacon response. IoT system A is still a search state, and can receive a beacon response. Upon receiving a beacon response from IoT system B, IoT system B is discovered. The timing that each IoT system stays in listening mode varies so that IoT systems have more probability to find each other.

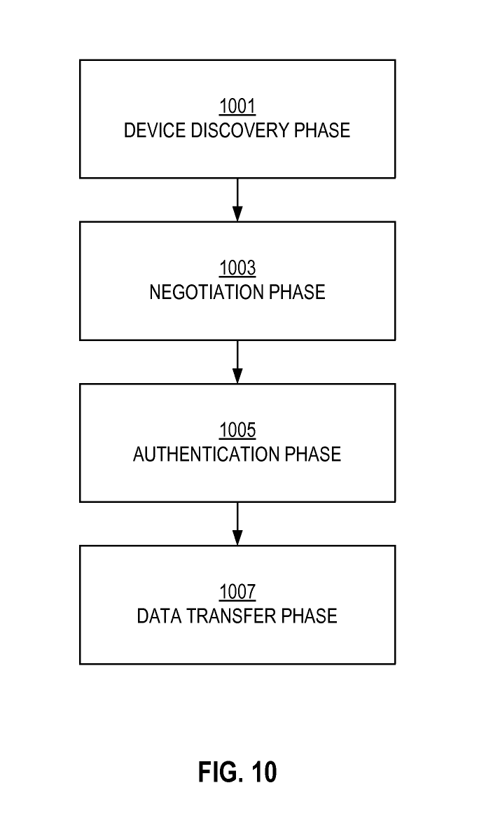

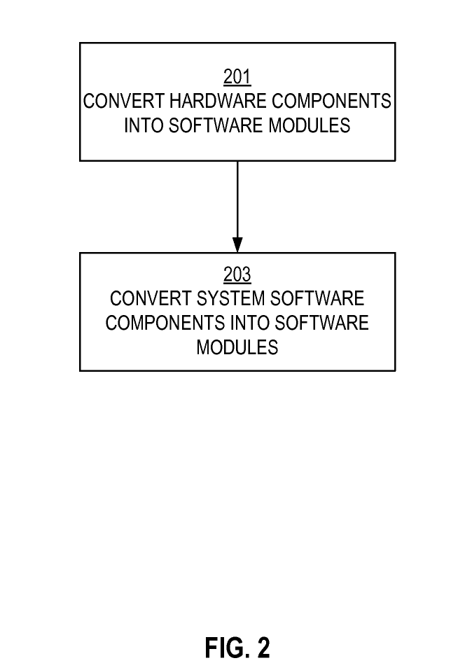

FIG. 10 illustrates one example of the App Exchange process according to some embodiments. At step 1001, IoT system A and IoT system B discover each other, as shown in the process described with reference to FIG. 6. At step 1003, a Negotiation phase occurs, where two IoT systems agree on the way that communication will take place, agree on the role of each device, and exchange information about their supported Apps and services.

At step 1005, an Authentication phase occurs, where the IoT systems authenticate to each other and establish a secure communication channel. In some embodiments, the Authentication phase does not occur if either of the devices does not support authentication. Beacons exchanged during the discovery phase establishes whether any authentication/security mechanism is supported based on the beacon authentication capabilities field. Upon receive the information by such beacon, other IoT system determines whether to continue or to reject any further communication.

At step 1007, a Data Transfer phase occurs where the actual App or Lib exchange takes place.

In accordance with another aspect of present embodiments of the invention, Apps can communicate and use other Apps or Libs that run remotely from another IoT system or other remote computer system. These distributed IoT Apps are hereinafter referred to as Super Apps. In some embodiments, Super Apps make use of nearby or remote IoT systems and collect information, control or configure other IoT systems for achieving a common objective.

Super Apps allow an IoT system to use the resources of nearby IoT systems for its own purposes. For example, an IoT wearable device like a smart watch can use the sensors of an IoT thermometer device to get the outside temperature. Based on the temperature, the smart watch sends a command to a coffee maker IoT system to prepare hot or cold coffee.

In some embodiments, a network of smart smoke detectors and smart thermometers are installed and located inside and outside the house. One smart smoke detector in the network detects an increase in CO₂ levels, triggering a detection of a potential fire. The smart smoke detector further initiates a Super App to request additional data from other smoke detectors and thermometers in the network to collect additional data. As such, a smoke detector in the network is “smart” enough to communicate and to “feel” the presence of another smart device on the network without any user intervention. The additional data collected by use of the Super App can then be analyzed by the initiating smart smoke detector to determine if there is a true fire requiring sounding an alarm, or merely another non-critical smoke-producing event, like a person smoking. The Super App may also trigger communications with a wearable device, such a smart watch, to alert a user by a vibration or local alarm from the wearable device, and to request a response at the wearable device acknowledging receiving the signal. If an acknowledgment is received from the smart watch, and the Super App detects that the CO₂ levels and temperature levels have decreased, then the house alarm will not sound.

According to some embodiments, execution of a Super App employs steps similar to those used in the App Exchange process, including the Discovery, Negotiation, and Authentication phases to establish a secure connection and communication between two IoT systems. The Super App further causes the IoT systems to enter a Chat phase. During the Chat phase an IoT system sends a Chat Request data packet that specifies the parameters of the data exchange. Specifically, the Chat Request data packet includes the following:

a) Request: for receiving data, or for sending a command;

b) Type: the type/format of the data or command; and

c) Flow: whether the data will be received only once or continuously or aggregated in time intervals.

The IoT system that received the Chat Request packet responds with a Chat Response data packet that contains the information below

a) Response: whether the request is accepted. If it is not accepted, a reason code is returned;

b) Data: the body of the reply comprising requested data or a command to the IoT system;

c) More Data: for a sequence of Response packets comprising one response.

Other features, aspects and objects of the invention can be obtained from a review of the figures and the claims. It is to be understood that other embodiments of the invention can be developed and fall within the spirit and scope of the invention and claims.

The foregoing description of embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. An embedded device, comprising:
a memory storing an embedded architecture, said embedded architecture comprising a core framework;
the core framework comprising a sequence of one or more instructions, which when executed by one or more processors of the embedded device, implements a method for providing a hardware abstraction for one or more hardware components of said embedded device, said method comprising the steps of:
generating one or more hardware interfaces for one or more hardware components of the embedded device,
generating at least a first module, wherein said first module comprises a first set of objects that is used by a plurality of application processes to provide data and commands to the one or more hardware components through said one or more hardware interfaces, and
generating at least a second module, wherein said second module comprises a second set of objects that is used by the plurality of application processes to provide data and commands to one or more system components;
wherein the first set of objects and the second set of objects are operable with each application of said plurality of applications, wherein each of said plurality of application processes is configured to be operable with a second embedded device running said embedded architecture, and wherein said second embedded device has at least one or more different hardware components or one or more different system specifications than the embedded device.

2. The embedded device of claim 1, wherein the embedded device is configured to replace a running application process with a different application process without stopping the core framework.

3. The embedded device of claim 2, wherein the different application process is accessed from another embedded device.

4. The embedded device of claim 2, wherein the different application process is accessed from a network link or from local storage.

5. The embedded device of claim 1, the core framework comprising a second sequence of one or more instructions, which when executed by one or more processors of the embedded device, implements a method for sending to the second embedded device one or more applications or libraries, said method comprising the steps of:
discovering the second embedded device,
exchanging information with the second embedded device about applications and libraries of the embedded device and the second embedded device; and
sending an application or a library for replacing an application or a library of the second embedded device,
wherein the embedded device is configured to replace a running application process with a different application process without stopping the core framework of the embedded device.

6. The system of claim 5, wherein the step of discovering the second embedded device includes sending beacons and receiving beacon responses from the second device.

7. The system of claim 5, wherein the core framework is configured to execute the step of: establishing a secure communication channel between the embedded device and the second embedded device.

8. The system of claim 5, wherein the embedded system initiates the method for sending one or more applications or libraries to the second embedded device based on one or more triggering events.

9. The system of claim 8, where the one or more triggering events include sending one or more beacons indicating the updated application process is available on the embedded device.

10. The embedded device of claim 1, wherein the embedded architecture is configured to replace the core framework with a different core framework.

11. The embedded device of claim 1, wherein the embedded device is configured to operate a distributed application process, wherein a first portion of the distributed application process is stored and run on a first embedded device, and a second portion of the distributed application process is stored and run on a second embedded device, the distributed application instructing the first embedded device to perform a task relied on by the second embedded device.

12. The embedded device of claim 2, wherein another embedded device instructed the different application process to be installed on the embedded device.

13. An embedded device, comprising:
a memory storing an embedded architecture, said embedded architecture comprising a core framework;
the core framework comprising a sequence of one or more instructions, which when executed by one or more processors of the embedded device, implements a method for providing a hardware abstraction for a microcontroller unit of said embedded device, said method comprising the steps of:
generating one or more hardware interfaces for the microcontroller unit of the embedded device,
generating at least a microcontroller unit module, wherein said microcontroller unit module comprises a first set of objects that are used by a plurality of different application processes to provide data and commands to the microcontroller unit of the embedded device through said one or more hardware interfaces, and
generating at least a network module, wherein said network module comprises a second set of objects that is used by the plurality of different application processes to provide data and commands to a network stack;
wherein the first set of objects and the second set of objects are operable with each application of said plurality of different applications, wherein each of said plurality of different application processes is configured to be operable with a second embedded device running said embedded architecture, and wherein said second embedded device has at least one or more different microcontroller units or one or more different network stack than the embedded device.

14. The embedded device of claim 13, wherein the embedded device is a Wi-Fi-enabled thermostat device.

15. The embedded device of claim 14, wherein an application of said plurality of applications is a thermostat application.

16. The embedded device of claim 13, said method further comprising the step of generating at least a WLAN module, wherein said WLAN module comprises at least an object that is used by an application to connect the embedded device to a WLAN, wherein said application is configured to be operable with a different embedded device with a different network stack running said embedded architecture.

17. A computer-implemented embedded platform for an embedded device, comprising:
an embedded architecture stored in the memory of the embedded device, said embedded architecture comprising a core framework;
the core framework comprising a sequence of one or more instructions, which when executed by one or more processors of the embedded device, implements a method for providing a hardware abstraction for one or more hardware components of said embedded device, said method comprising the steps of:
generating one or more hardware interfaces for one or more hardware components of the embedded device,
generating at least a first module, wherein said first module comprises a first set of objects that is used by a plurality of application processes to provide data and commands to the one or more hardware components through said one or more hardware interfaces, and
generating at least a second module, wherein said second module comprises a second set of objects that is used by the plurality of application processes to provide data and commands to one or more system components;
wherein the first set of objects and the second set of objects are operable with each application of said plurality of applications, wherein each of said plurality of application processes is configured to be operable with a second embedded device running said embedded architecture, and wherein said second embedded device has at least one or more different hardware components or one or more different system specifications than the embedded device.

18. The embedded platform of claim 17, wherein the embedded device is configured to replace a running application process with a different application process without stopping the core framework.

19. The embedded platform of claim 18, wherein the different application process is accessed from another embedded device.

20. The embedded platform of claim 18, wherein the different application process is accessed from a network link or from local storage.

21. The embedded platform of claim 17, wherein the embedded architecture is configured to replace the core framework with a different core framework.

22. The embedded platform of claim 17, wherein the embedded device is configured to operate a distributed application process, wherein a first portion of the distributed application process is stored and run on a first embedded device, and a second portion of the distributed application process is stored and run on a second embedded device, the distributed application instructing the first embedded device to perform a task relied on by the second embedded device.

23. The embedded platform of claim 18, wherein another embedded device instructed the different application process to be installed on the embedded device.

24. The embedded device of claim 11, wherein the first and the second embedded devices are smart smoke detectors, and the task comprises the first embedded device determining a carbon dioxide level and reporting it to the second embedded device.

25. The embedded device of claim 11, wherein a third portion of the distributed application process is stored and run on a mobile computing device, and the task relied on by the second embedded device comprises the first embedded device determining a temperature and reporting said temperature to the second embedded device.
